(19) United States
(12) Patent Application Publication
(10) Pub. No.: US 2016/0001600 A1
(43) Pub. Date: Jan. 7, 2016

(54) REINFORCING PLY FOR ARTICLES MADE OF AN ELASTOMERIC MATERIAL, PREFERABLY FOR PNEUMATIC VEHICLE TIRES AND PNEUMATIC VEHICLE TIRES

(71) Applicant: Continental Reifen Deutschland GmbH, Hannover (DE)

(72) Inventors: Carole Justine, Scharrel (DE); Thomas Kramer, Herford (DE); Guenter Wahl, Hohenhameln (DE)

(21) Appl. No.: 14/854,877

(22) Filed: Sep. 15, 2015

Related U.S. Application Data
(63) Continuation of application No. PCT/EP2014/053564, filed on Feb. 25, 2014.

(30) Foreign Application Priority Data
Mar. 18, 2013 (EP) 13159770.0

(51) Int. Cl. B60C 9/00; B60C 9/18; D07B 1/06; B60C 5/00; D02G 3/48; B60C 9/02; B60C 15/00

(52) U.S. Cl. CPC B60C 9/005; B60C 9/0042; B60C 9/02; B60C 9/18; B60C 15/00; B60C 5/00; D02G 3/48; D07B 1/0606; B60C 2009/0078; B60C 2009/0035; D10B 2201/24; D10B 2331/02; D10B 2331/04; D10B 2331/021

(57) ABSTRACT

A rubberized reinforcing ply for articles made of an elastomeric material, specifically vehicle tires, which have a plurality of parallel tire cords spaced apart from one another and the tire cords are hybrid cords of at least two multifilament yarns twisted together. The first multifilament yarn is a viscose multifilament yarn and the other multifilament yarn is a non-metallic multifilament yarn made of a material that is not identical to the first multifilament yarn. The viscose multifilament yarn is conditioned in a standard atmosphere according to DIN EN ISO 139-1:2005 and after conditioning has a yarn titer<1100 dtex and a tensile strength≧45 cN/tex. The hybrid cord has a core titer≦3000 dtex.

### CROSS REFERENCE TO RELATED APPLICATIONS

This application is a continuation application of international patent application PCT/EP2014/053564, filed Feb. 25, 2014, designating the United States and claiming priority from European application 13159770.0, filed Mar. 18, 2013, and the entire content of both applications is incorporated herein by reference.

### FIELD OF THE INVENTION

The invention relates to a rubberized reinforcement ply for articles made of an elastomeric material, preferably for vehicle tires, wherein the reinforcement ply comprises a multiplicity of mutually spaced-apart strength members in a parallel arrangement, wherein the strength members are hybrid cords composed of at least two multifilament yarns twisted with one another, the first multifilament yarn being a viscose multifilament yarn and the further multifilament yarn being a nonmetallic multifilament yarn which is composed of material which is not identical with the first multifilament yarn. The invention further relates to a pneumatic vehicle tire containing this reinforcement ply.

### BACKGROUND OF THE INVENTION

Reinforcement plies for articles made of an elastomeric material such as, for example, industrial rubber products and (pneumatic) vehicle tires have the utmost importance and are common general knowledge to those skilled in the art. The reinforcement plies incorporate a multiplicity of reinforcing thread-shaped elements, which are known as strength members. These are completely embedded in elastomeric material. The strength members of these reinforcement plies have, for example, the form of woven fabrics or of calendered strength members wound in a continuous manner.

Where the strength members composed of at least two yarns each include different materials, these strength members are called hybrid cords. The use of a hybrid cord allows tailoring of the physical properties of the strength member by means on the one hand of targeted selection of material for the individual yarns, and on the other hand the yarn construction.

The rubberized reinforcement plies of suitable size and configuration are combined with further component parts to form an industrial rubber product or a pneumatic vehicle tire. The function of the rubberized reinforcement plies in the product in question is to reinforce it.

An aforementioned reinforcement ply was disclosed for example by DE 10 2009 003 359 A1. The reinforcement ply is a belt bandage of a pneumatic vehicle tire, comprising strength members consisting of hybrid cords of two yarns, a rayon multifilament yarn and a PET multifilament yarn. The rayon multifilament yarn comes under the heading of the viscose multifilament yarns. The linear density of the rayon multifilament yarn is 1840 dtex; the linear density of the PET multifilament yarn is 1440 dtex. The hybrid cord has a hitherto customary diameter. The diameters of the strength members critically determine the thickness of the reinforcement ply embedding these strength members. Strength members with low diameter allow comparatively thinner reinforcement plies than strength members with a large diameter.

For reasons of cost saving, however, efforts are made to use reinforcement plies of reduced thickness in elastomer products, although the reinforcement plies are intended to have roughly the same physical properties as reinforcement plies with hitherto customary thickness. Moreover, environmental concerns are driving efforts to use as far as possible natural, renewable raw materials for the strength members of these reinforcement plies.

### SUMMARY OF THE INVENTION

The problem addressed herein is therefore that of providing a comparatively thin reinforcement ply for articles made of an elastomeric material, being of eco-friendly design and having physical properties roughly equivalent to those of reinforcement plies used to date with synthetic strength members. A problem addressed by the invention is further that of providing a pneumatic vehicle tire made in an environmentally friendly manner and having a comparatively low rolling resistance.

The problem is solved in respect of the reinforcement ply when the viscose multifilament yarn after conditioning in a DIN EN ISO 139-1:2005 standard atmosphere has a yarn linear density<1100 dtex and a tenacity of ≧45 cN/tex and also when the hybrid cord has a cord linear density≦3000 dtex.

A comparatively thin reinforcement ply is provided, whose strength member is a hybrid strength member composed of at least two multifilament yarns, one of them being a viscose multifilament yarn. The cord linear density is ≦3000 dtex, thereby permitting a comparatively thin hybrid cord and therefore a comparatively thin reinforcement ply. Viscose multifilament yarns are obtainable by the so-called “viscose process” from cellulose. Cellulose is the most frequent and significant natural, renewable and thus environmentally friendly polymer around the world. Hitherto it has been necessary to use thick strength members with viscose or rayon multifilament yarns having a yarn linear density>1840 dtex in rubberized reinforcement plies in the tire, to provide the tenacity necessary for service. Now, on the basis of a modified method for production of the viscose yarn, the possibility has been provided of manufacturing a thin viscose multifilament yarn having for viscose a surprisingly high tenacity of ≧45 cN/tex. A surprise is that a reinforcement ply with hybrid cords comprising at least one viscose multifilament yarn having a yarn linear density<1100 dtex is very useful in industrial rubber products, especially in (pneumatic) vehicle tires.

The reinforcement ply of the invention has in particular the breaking force, elastic modulus, fatigue resistance, and elongation at break to meet the requirements for service in a pneumatic vehicle tire in particular.

The hybrid cord of the reinforcement ply of the invention may include two or more multifilament yarns, of which a first multifilament yarn is always an above-described “thin” viscose multifilament yarn, and of which a second multifilament yarn always is made of a material which is not identical with the first multifilament yarn. The hybrid cord may, however, also comprise three or more multifilament yarns, of which a third multifilament yarn or further multifilament yarn may be identical with the material of the first or second multifilament yarn or else may be made of a further nonmetallic material. The further nonmetallic material may be a polyester multifilament yarn, preferably a polyester terephthalate (PET) multifilament yarn, and more preferably a high modulus low shrinkage PET multifilament yarn.

The conditioned textile data of the viscose multifilament yarn are measured in accordance with DIN EN ISO 2062:2009 under the following conditions:
conditioning times of ≧16 h in a standard atmosphere
CRE tensile tester with pneumatic clamps [CRE: constant rate of extension]
testing of multifilament yarns with a producer twist of 100 t/m (t/m=turns/meter)
clamped length of specimens: 500 mm
extension rate (crosshead speed): 500 mm/min (100%/min).

The conditioning and testing conditions stated in the aforementioned standards are comparable to the pertinent standard of the manufactured fiber industry (BISFA “Testing methods for viscose, cupro, acetate, triacetate and lyocell filament yarns”, 2007 Edition).

The viscose multifilament yarn is surprisingly obtained when the process described in Example 2 of GB 685,631 is modified in several technical features, as described hereinbelow.
Coniferous pulps were used instead of cotton linters.
The viscose is admixed with viscose modifiers (for example, amine ethoxylates such as ethoxylated fatty acid amines or polyethylene glycols such as PEG 1500) in a concentration ranging from 0.01 to 1.0 wt % based on viscose prior to spinning.
The spinneret dies used have a hole diameter<100 μm, preferably in the range from 40 to 80 μm.
Spinning speed at the first takeup roll is less than 50 m/min and is preferably in the range from 10 to 40 m/min.
The thread is transported from the spinneret die into the coagulation bath through a spinning tube, the transportation of the thread in the spinning tube being augmented by a coagulation bath current in the direction of fiber takeoff.
Sulfuric acid concentration in the coagulation bath is greater than 15 g/liter and is preferably in the range from 20 to 120 g/liter.
Sodium sulfate and zinc sulfate are added to the coagulation bath, preferably in a concentration of 25 to 250 g/liter coagulation bath.
Coagulation bath temperature is more than 30° C., and is preferably in the range from 40 to 95° C.
The subsequent fixing bath contains sulfuric acid, preferably in a concentration ranging from 20 to 120 g/liter fixing bath, and also serves as decomposition bath for cellulose xanthate.
The spun yarn is stretched to more than 175%; preferably the stretch is in a range from 180% to 220%.
The viscose multifilament yarn of the invention is preferably produced in a two-step process wherein the yarn is spun and wound up in the first step and the wound-up yarn is unwound and stretched in the second step.

It is advantageous for the further multifilament yarn to have a yarn linear density in the range of ≧50 and ≦1800 dtex, preferably in the range of ≧200 and ≦1200 dtex, more preferably in the range of ≧250 and ≦800 dtex. This provides a comparatively thin reinforcement ply with hybrid cords whose yarns each have a low linear density and hence a low overall cord diameter, but whose physical properties approximate to those of hybrid cords with presently customary diameters.

The viscose multifilament yarn is a rayon multifilament yarn or a lyocell multifilament yarn.

It is advantageous for the hybrid cord to have a cord linear density≦2500 dtex, preferably ≦2000 dtex.

It is advantageous for the viscose multifilament yarn to have a yarn linear density in the range of ≧150 dtex to <1100 dtex, preferably in the range of ≧170 dtex to <900 dtex, and a tenacity in the range of ≧45 cN/tex to ≦60 cN/tex, preferably in the range of ≧45 cN/tex to ≦56 cN/tex. The high tenacity per dtex allows a thin yarn linear density in relation to the breaking force.

It is useful for the viscose multifilament yarn to have a yarn linear density in the range of ≧170 dtex to <900 dtex, preferably of ≧200 dtex to <800 dtex, and a tenacity in the range of ≧45 cN/tex to ≦56 cN/tex, preferably of ≧45 cN/tex to ≦53 cN/tex. This produces advantages in relation to the fatigue properties of a pneumatic vehicle tire that uses the reinforcement ply of the invention as its carcass ply and/or as its belt bandage, and also in relation to the operational functionality of the reinforcement ply manufacturing procedure.

It is advantageous for the fatigue resistance of a pneumatic vehicle tire utilizing the reinforcement ply of the invention as its carcass ply and/or as its belt bandage when the viscose multifilament yarn has a filament linear density in the range of 1.2 and 4.0 dtex, preferably of 2.4 and 3.0 dtex.

It is useful for the viscose multifilament yarn to have an elongation at break in the range of ≧5% and ≦20%, preferably of ≧6% and ≦15%. An industrial rubber product or a pneumatic vehicle tire having such a reinforcement ply as its carcass ply and/or as its belt bandage is more fatigue-resistant, even under extreme conditions such as instances of curbstone contact, and/or is particularly suitable for high-speed uses.

In one embodiment, the further nonmetallic multifilament yarn is an aramid multifilament yarn and/or a polyamide multifilament yarn, preferably a PA66 multifilament yarn. A higher elastic modulus and lower contraction and also a higher stability in conjunction with lower cord diameter is achieved than in the case, for example, of a PA66 940×2 cord construction.

In a preferred embodiment, the reinforcement ply comprises a hybrid cord composed of two multifilament yarns, of which the first multifilament yarn is a rayon multifilament yarn and of which the further multifilament yarn is a PA66 multifilament yarn, and where construction of the hybrid cord is rayon 780×1+PA66 700×1, preferably twisted with 450 tpm S(Z)+450 tpm S(Z), 450 tpm Z(S). The filaments of each rayon multifilament yarn have a filament linear density of 3 dtex. The tenacity of a rayon multifilament yarn is in the range of ≧45 cN/tex to ≦53 cN/tex. Each rayon multifilament yarn has an elongation at break in the range of ≧6% and ≦15%. The hybrid cord has a diameter of 0.48 mm. Other parameters of the hybrid cord can be seen from Table 1. The hybrid cords are arranged in a density of 60 to 190 epdm, preferably in a density of 120 to 170 epdm, in the reinforcement ply, which is preferably a belt bandage.

In another preferred embodiment, the reinforcement ply comprises a hybrid cord composed of likewise two multifilament yarns, of which the first multifilament yarn is a rayon multifilament yarn and of which the further multifilament yarn is an aramid multifilament yarn, and where construction of the hybrid cord is rayon 620×1+aramid 550×1, preferably twisted with 600 tpm S(Z)+600 tpm S(Z), 600 tpm Z(S). The filaments of each rayon multifilament yarn have a filament linear density of 2.4 dtex. The tenacity of a rayon multifilament yarn is in the range of ≧45 cN/tex to ≦53 cN/tex. Each rayon multifilament yarn has an elongation at break in the range of ≧6% and ≦15%. The hybrid cord has a diameter of 0.40 mm. Other parameters of the hybrid cord can be seen from Table 1. The hybrid cords are arranged in a density of 60 to 210 epdm, preferably in a density of 150 to 200 epdm, in the reinforcement ply.

In yet another embodiment, the reinforcement ply comprises a hybrid cord composed of three multifilament yarns, of which the first multifilament yarn is a rayon multifilament yarn, of which the second multifilament yarn is an aramid multifilament yarn, and of which the third multifilament yarn is a rayon multifilament yarn identical with the first multifilament yarn, and where construction of the hybrid cord is rayon 620×1+aramid 550×1+rayon 620×1, preferably twisted with 600 tpm S(Z)+600 tpm S(Z), 600 tpm Z(S). The filaments of each rayon multifilament yarn have a filament linear density of 2.4 dtex. The tenacity of a rayon multifilament yarn is in the range of ≧45 cN/tex to ≦53 cN/tex. Each rayon multifilament yarn has an elongation at break in the range of ≧6% and ≦15%. The hybrid cord has a diameter of 0.50 mm. Other parameters of the hybrid cord can be seen from Table 1. The hybrid cords are arranged in a density of 60 to 190 epdm, preferably in a density of 120 to 170 epdm, in the reinforcement ply.

It is advantageous for the hybrid cord to be arranged in a density of 60 epdm to 280 epdm in the reinforcement ply.

“epdm” denotes ends per decimeter and describes the cord density in the reinforcement ply.

Apart from that, the nature or makeup of the cellulosic fibers is not subject to any restrictions. The viscose multifilament yarn is thus processable as such or as short-cut fiber into a strength member, into a woven or knitted fabric. It is also possible to use the strength member containing the viscose multifilament yarn directly in the manufacture of a tire.

The invention is solved in respect of the pneumatic vehicle tire when the latter comprises a rubberized reinforcement ply as described above.

The reinforcement ply therein is in particular a carcass and/or a belt bandage and/or a bead reinforcer.

Table 1 hereinbelow gives an exemplary overview of hybrid cords which are used in the reinforcement ply of the invention, and their density in the reinforcement ply in epdm.

TABLE 1

| | Example | | |
|---|---|---|---|
| Parameter | 1 | 2 | 3 |
| Material | Rayon + | Rayon + | Rayon + Aramid + |
| | PA66 | Aramid | Rayon |
| Cord | 780 × 1 + | 620 × 1 + | 620 × 1 + 550 × |
| construction | 700 × 1 | 550 × 1 | 1 + 620 × 1 |
| Turns [tpm] | 450 | 600 | 600 |
| Density | 80 | 150 | 170 |
| [epdm] | | | |
| Cord | 5.8 | 15.6 | 19.6 |
| breaking | | | |
| force | | | |
| [kN/dm] | | | |
| Elongation | 10 | 6.6 | 8.5 |
| at break [%] | | | |
| Diameter | 0.48 | 0.40 | 0.50 |
| [mm] | | | |

### BRIEF DESCRIPTION OF THE DRAWINGS

The invention will now be described with reference to the drawings wherein:

FIG. 1 shows force-elongation curves with two unrubberized fabrics in kN/dm; and,

FIG. 2 shows force-elongation curves with three unrubberized fabrics in kN/dm.

### DESCRIPTION OF THE PREFERRED EMBODIMENTS OF THE INVENTION

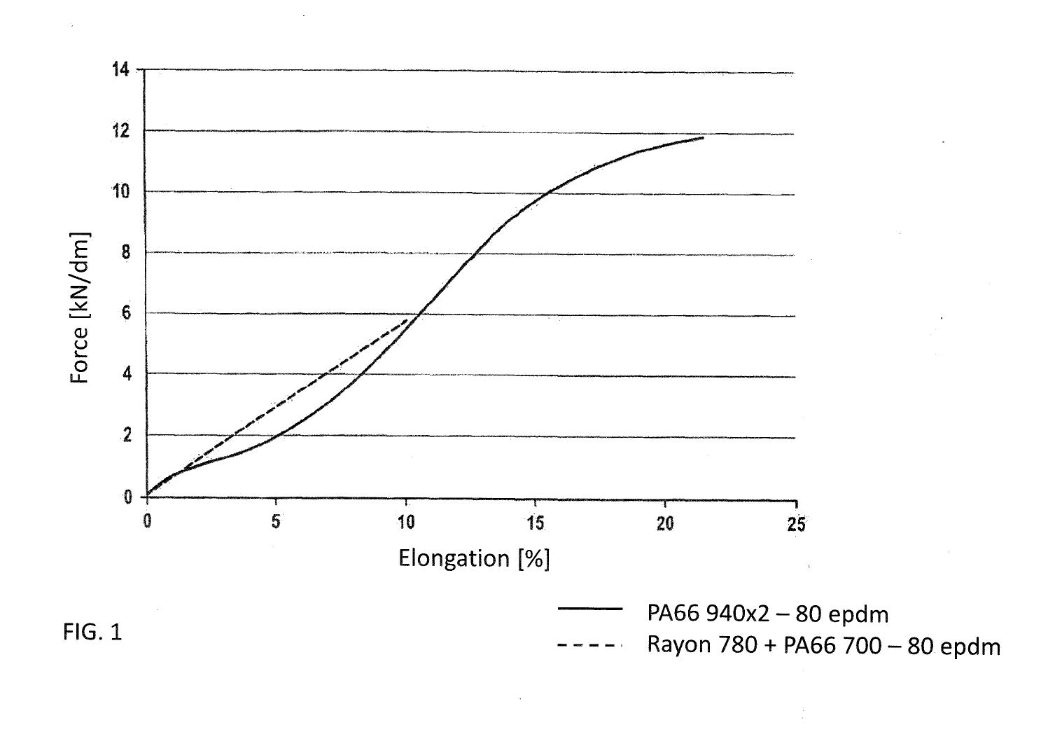

FIG. 1 shows force-elongation curves with two unrubberized fabrics in kN/dm, with one fabric comprising the hybrid cord 1 described in Table 1 (rayon 780+PA66 700) and the other fabric comprising a prior-art cord (PA66 940×2).

Hybrid cord 1 is used for example preferably as a woven fabric in the belt bandage reinforcement ply of a pneumatic vehicle tire. The elastic modulus of the hybrid cord is advantageously comparatively high as a result of the rayon multifilament yarn, while PA66 is responsible for the contraction effect that is necessary for belt bandage application.

The improvement in rolling resistance of a pneumatic vehicle tire with the reinforcement ply of the invention, in spite of a higher cord density, is between 1% to 3%, but is dependent on the tire sizing and tire construction.

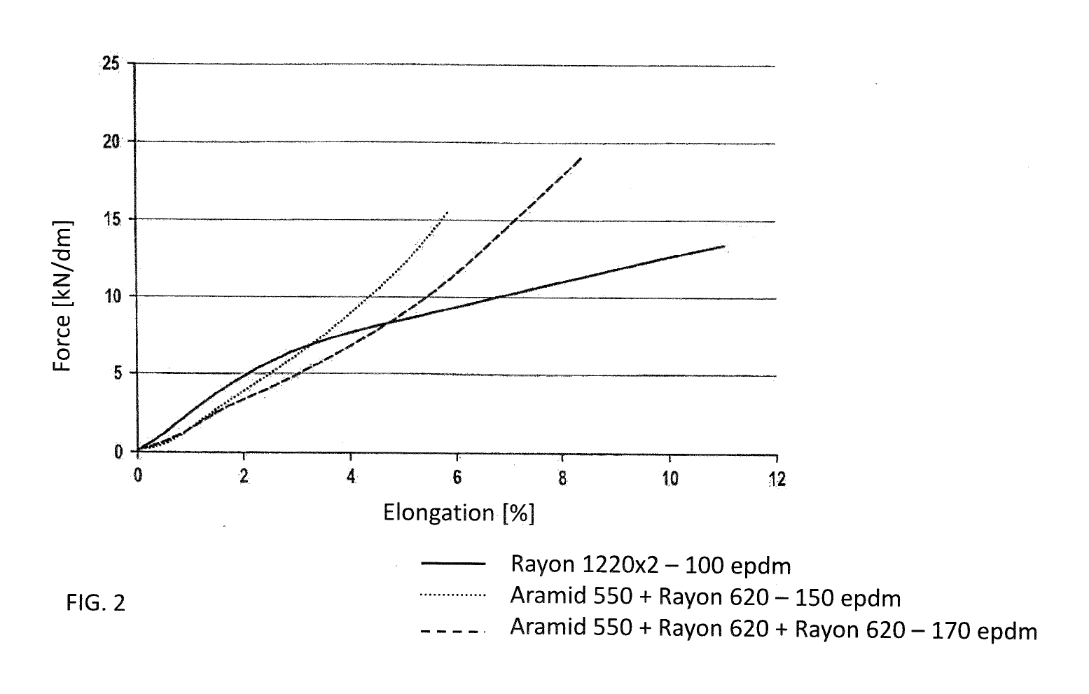

FIG. 2 shows force-elongation curves with three unrubberized fabrics in kN/dm, with one fabric comprising the hybrid cord 2 described in Table 1 (rayon 620+aramid 550), a further fabric comprising the hybrid cord 3 described in Table 1 (rayon 620+aramid 550+rayon 620), and the third fabric comprising a prior-art cord (rayon 1220×2).

The force-elongation measurements are carried out in accordance with ASTM D885.

Hybrid cords 2 and 3 are used for example preferably in woven fabrics in the carcass reinforcement ply of a pneumatic vehicle tire. The elastic modulus of the hybrid cord is advantageously comparatively high as a result of the rayon multifilament yarn, while aramid is responsible for an advantageously high overall breaking force.

The improvement in rolling resistance of a pneumatic vehicle tire with the reinforcement ply of the invention, in spite of a higher cord density, is between 2% to 4%, but is dependent on the tire sizing and tire construction.

It is understood that the foregoing description is that of the preferred embodiments of the invention and that various changes and modifications may be made thereto without departing from the spirit and scope of the invention as defined in the appended claims.

What is claimed is:

1. A rubberized reinforcement ply for articles made of an elastomeric material, the reinforcement ply comprising:
a multiplicity of mutually spaced-apart strength members in a parallel arrangement,
wherein the strength members are hybrid cords composed of at least two multifilament yarns twisted with one another, the first multifilament yarn being a viscose multifilament yarn and the further multifilament yarn being a nonmetallic multifilament yarn which is composed of a material not identical with the first multifilament yarn,
wherein the viscose multifilament yarn after conditioning in a DIN EN ISO 139-1:2005 standard atmosphere has a yarn linear density<1100 dtex and a tenacity of ≧45 cN/tex, and
wherein the hybrid cord has a cord linear density≦3000 dtex.

2. The rubberized reinforcement ply as claimed in claim 1, wherein the further multifilament yarn has a yarn linear density in the range of ≧50 and ≦1800 dtex.

3. The rubberized reinforcement ply as claimed in claim 1, wherein the hybrid cord has a cord linear density≦2500 dtex.

4. The rubberized reinforcement ply as claimed in claim 1, wherein the viscose multifilament yarn has a yarn linear density in the range of ≧150 dtex to <1100 dtex and a tenacity in the range of ≧45 cN/tex to ≦60 cN/tex.

5. The rubberized reinforcement ply as claimed in claim 4, wherein the viscose multifilament yarn has a yarn linear density in the range of ≧200 dtex to <800 and a tenacity in the range of ≧45 cN/tex to ≦53 cN/tex.

6. The rubberized reinforcement ply as claimed in claim 1, wherein the viscose multifilament yarn has a filament linear density in the range of 1.2 and 4.0 dtex.

7. The rubberized reinforcement ply as claimed in 1, wherein the viscose multifilament yarn has an elongation at break in the range of ≧5% and ≦20%.

8. The rubberized reinforcement ply as claimed in claim 1, wherein the further nonmetallic multifilament yarn is an aramid multifilament yarn and/or a polyamide multifilament yarn.

9. The rubberized reinforcement ply as claimed in claim 1, wherein the further nonmetallic multifilament yarn is a polyester multifilament yarn.

10. The rubberized reinforcement ply as claimed in claim 1, wherein the first viscose multifilament yarn is a rayon multifilament yarn and in that the further multifilament yarn is a PA66 multifilament yarn, the construction of the hybrid cord being rayon 780×1+PA66 700×1.

11. The rubberized reinforcement ply as claimed in claim 1, wherein the first viscose multifilament yarn is a rayon multifilament yarn, and
wherein the further multifilament yarn is an aramid multifilament yarn, the construction of the hybrid cord being rayon 620×1+aramid 550×1.

12. The rubberized reinforcement ply as claimed in claim 1, wherein the first viscose multifilament yarn is a rayon multifilament yarn,
wherein the second multifilament yarn is an aramid multifilament yarn, and
wherein the third multifilament yarn is a rayon multifilament yarn identical with the first multifilament yarn,
the construction of the hybrid cord being rayon 620×1+aramid 550×1+rayon 620×1.

13. A pneumatic vehicle tire comprising at least one reinforcement ply as claimed in claim 1.

14. The pneumatic vehicle tire as claimed in claim 13, wherein the reinforcement ply is a carcass and/or a belt bandage and/or a bead reinforcer.

15. The rubberized reinforcement ply of claim 2, wherein the further multifilament yarn has a yarn linear density in the range of ≧200 and ≦1200 dtex.

16. The rubberized reinforcement ply of claim 2, wherein the further multifilament yarn has a yarn linear density in the range of ≧250 and ≦800 dtex.

17. The rubberized reinforcement ply of claim 3, wherein the hybrid cord has a cord linear density≦2000 dtex.

18. The rubberized reinforcement ply of claim 4, wherein the viscose multifilament yarn has a yarn linear density in the range of ≧170 dtex to <900 dtex and a tenacity in the range of ≧45 cN/tex to ≦56 cN/tex.

19. The rubberized reinforcement ply as claimed in claim 6, wherein the viscose multifilament yarn has a filament linear density in the range of 2.4 and 3.0 dtex.

20. The rubberized reinforcement ply as claimed in claim 7, wherein the viscose multifilament yarn has an elongation at break in the range of ≧6% and ≦15%.
